(19) United States
(12) Patent Application Publication
(10) Pub. No.: US 2013/0286682 A1
(43) Pub. Date: Oct. 31, 2013

(54) LIGHTING DEVICE AND BACK LIGHT MODULE THEREWITH

(71) Applicants: Chung-Wen Lin, Hsin-Chu (TW); Yu-Ling Hsiao, Hsin-Chu (TW); Shih-Ting Chen, Hsin-Chu (TW); Yuan-Yu Chien, Hsin-Chu (TW)

(72) Inventors: Chung-Wen Lin, Hsin-Chu (TW); Yu-Ling Hsiao, Hsin-Chu (TW); Shih-Ting Chen, Hsin-Chu (TW); Yuan-Yu Chien, Hsin-Chu (TW)

(73) Assignee: AU OPTRONICS CORP., Hsin-Chu (TW)

(21) Appl. No.: 13/550,569

(22) Filed: Jul. 16, 2012

(30) Foreign Application Priority Data
Apr. 25, 2012 (TW) 101114667

(51) Int. Cl. F21V 21/00; F21V 13/02; F21V 31/00

(52) U.S. Cl. 362/609; 362/249.01; 362/249.02

(57) ABSTRACT

A lighting device and a back light module therewith are disclosed. The back light module includes a light-guiding structure and a lighting device. The light-guiding structure includes two light-guiding parts and a reflection sheet disposed therebetween. The lighting device is disposed close to the light-guiding structure and includes an insulation carrier and two light sources disposed on the insulation carrier. The insulation carrier includes a positioning groove structure where an edge of the reflection sheet is disposed such that the two light sources correspond to the two light-guiding parts respectively and light emitted by the two light sources is capable of entering the corresponding light-guiding parts. Thereby, the invention uses the single-structure lighting device to simultaneously provide required light to the two light-guiding parts respectively, and uses the positioning structure formed on the lighting device to improve the assembly preciseness of the light-guiding structure with the lighting device.

### BACKGROUND OF THE INVENTION

1. Field of the Invention

The invention relates to a lighting device and a back light module, and especially relates to a lighting device capable of providing two light sources and a back light module having the lighting device for providing two back lights.

2. Description of the Prior Art

As use customs of users become various, there is a displaying apparatus capable of providing a forward screen and a backward screen by a single apparatus configuration on the market. For current back light modules with dual screens, some are designed to use a single lighting device to provide light to two light-guiding plates simultaneously. Some are designed to use a single lighting device to provide light to a light-guiding plate and use a semi-transmitting and semi-reflecting structure to guide the light in the light-guiding plate to another light-guiding plate. Still some are designed to use two lighting devices to provide light to corresponding light-guiding plates respectively. In the above configurations, each of the light-guiding plates is used for providing light to a corresponding liquid crystal panel.

In the above first configuration, it is not easy to precisely align the lighting device with the light-guiding plate, leading to an unpredictable intensity of light into each light-guiding plate. In the above second configuration, the preciseness of the assembly for the lighting device with the light-guiding plates can be controlled precisely. The light for the second light-guiding plate is from the first light-guiding plate, so it is difficult to enhance the intensity of the light into the second light-guiding plate so that the application scope of the liquid crystal panel corresponding to the second light-guiding plate is limited. In the above third configuration, in logic, the back light module consists of two independent liquid crystal stacked. The preciseness of the assembly therefor can also be controlled precisely. The intensity of the back light therefor can be controlled independently. But it is obviously difficult to decrease the volume of the whole displaying apparatus.

### SUMMARY OF THE INVENTION

An objective of the invention is to provide a lighting device, using a positioning structure between two light sources for disposing a reflection sheet therein such that after assembled, the lighting device is capable of precisely providing required light to light-guiding parts.

The lighting device of the invention includes an insulation carrier, a first light source, and a second light source. The insulation carrier has a package space and a light-out side. The light-out side thereon defines a first light-out area and a second light-out area. The insulation carrier includes a positioning groove structure for positioning a reflection sheet such that the reflection sheet divides the light-out side into the first light-out area and the second light-out area. The first light source is disposed in the package space corresponding to the first light-out area. Light emitted from the first light source emits through the first light-out area out of the lighting device. The second light source is disposed in the package space corresponding to the second light-out area. Light emitted from the second light source emits through the second light-out area out of the lighting device. Thereby, when the reflection sheet is disposed in the positioning groove structure, light-guiding parts at two opposite sides of the reflection sheet can be disposed corresponding to the first light-out area and the second light-out area precisely, and the intensity of the light into the light-guiding parts can be easily controlled by use of the first light source and the second light source.

Another objective of the invention is to provide a back light module having the lighting device of the invention. The back light module uses a single-structure lighting device to provide required light to two light-guiding parts simultaneously and uses a positioning structure formed on the lighting device to improve the assembly preciseness of the light-guiding structure and the lighting device.

The back light module includes a light-guiding structure and a lighting device. The light-guiding structure has a light-in side and includes a first light-guiding part, a second light-guiding part, and a reflection sheet. The lighting device is disposed close to the light-in side and contacts an edge of the reflection sheet. The lighting device includes an insulation carrier, a first light source, and a second light source. The insulation carrier has a package space and a light-out side. The light-out side is opposite to the light-in side. The light-out side thereon defines a first light-out area and a second light-out area. The insulation carrier includes a positioning groove structure. The edge of the reflection sheet is disposed in the positioning groove structure to divide the light-out side into the first light-out area and the second light-out area such that the first light-out area and the second light-out area are opposite to the first light-guiding part and the second light-guiding part respectively. The first light source is disposed in the package space corresponding to the first light-out area. Light emitted from the first light source emits through the first light-out area out of the lighting device to enter the first light-guiding part through the light-in side. The second light source is disposed in the package space corresponding to the second light-out area. Light emitted from the second light source emits through the second light-out area out of the lighting device to enter the second light-guiding part through the light-in side. Thereby, the back light module uses only the single-structure lighting device to precisely provide required light to the two light-guiding parts, which is conducive to reduction of a volume of an apparatus using the back light module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a lighting device of a preferred embodiment according to the invention.

FIG. 2 is a sectional view of the lighting device in FIG. 1 along the line X-X.

FIG. 3 is a sectional view of a lighting device according to another embodiment.

FIG. 4 is a top view of the lighting device in FIG. 1.

FIG. 5 is a top view of a lighting device according to another embodiment.

FIG. 6 is a top view of a lighting device according to another embodiment.

FIG. 7 is a sectional view of aback light module of a preferred embodiment according to the invention.

FIG. 8 is a sectional view of a back light module according to another embodiment.

### DETAILED DESCRIPTION

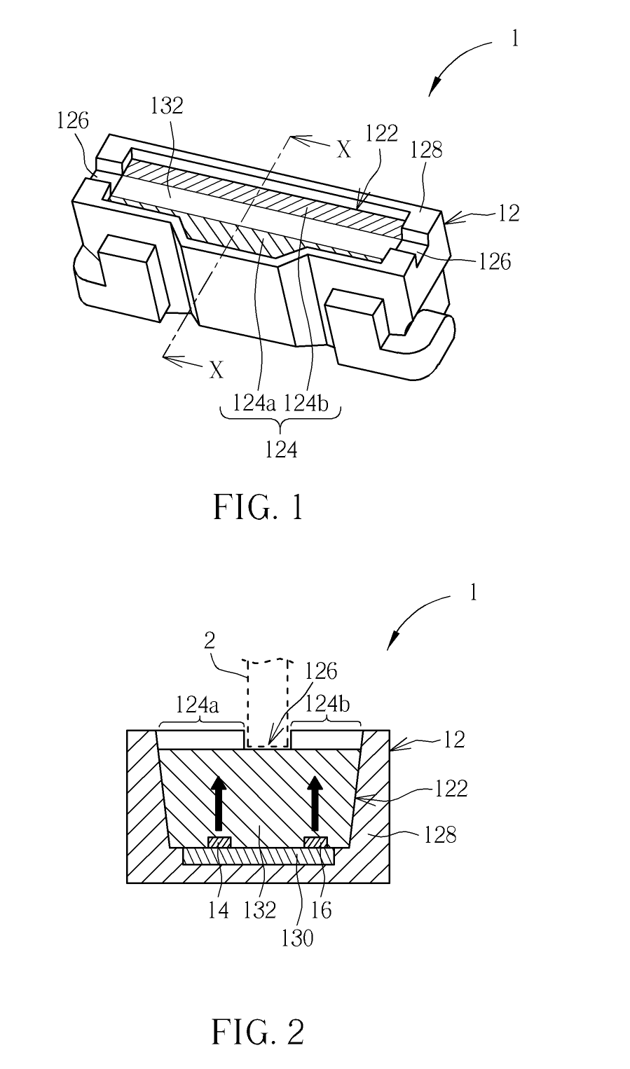

Please refer to FIG. 1 and FIG. 2. FIG. 1 is a schematic diagram illustrating a lighting device 1 of a preferred embodiment according to the invention. FIG. 2 is a sectional view of the lighting device 1 in FIG. 1 along the line X-X. The lighting device 1 includes an insulation carrier 12, a first light source 14, and a second light source 16. The insulation carrier 12 has a package space 122 and a light-out side 124. The light-out side 124 thereon defines a first light-out area 124a and a second light-out area 124b (shown by hatched lines in FIG. 1). The insulation carrier 12 includes a positioning groove structure 126 for a reflection sheet 2 (shown by dashed lines in FIG. 2) to be positioned thereon such that the reflection sheet 2 divides the light-out side 124 into the first light-out area 124a and the second light-out area 124b. The first light source 14 is disposed in the package space 122 corresponding to the first light-out area 124a. The second light source 16 is disposed in the package space 122 corresponding to the second light-out area 124b.

Thereby, light emitted from the first light source 14 emitting through the first light-out area 124a out of the lighting device 1; light emitted from the second light source 16 emitting through the second light-out area 124b out of the lighting device 1. Therein, bold lines with arrow show the primary light paths. In other words, in logic, the light passing through the two side of the reflection sheet 2 comes mainly from the first light source 14 and the second light source 16 respectively. Therefore, in practice, the light-out quantity by the lighting device 1 for each side of the reflection sheet 2 depends on the light-out quantity of either the first light source 14 or the second light source 16 correspondingly. It is added that, in practice, light emitted by the first light source 14 travels in a plurality of directions, so it is possible that a very few portion of the light may emit through the second light-out area 124b out of the lighting device 1. However, the light-out quantity of the portion of the light is obviously much less than the light-out quantity of the light emitting through the first light-out area 124a out of the lighting device 1, so the light-out quantity of the portion of the light can be regarded as being with an allowable tolerance so as to be ignored in practice. Furthermore, if the first light source 14 is designed properly in structure for convergence of the divergence angle of the first light source 14, the extent of the light from the first light source 14 emitting through the second light-out area 124b out of the lighting device 1 can be reduced effectively. The above explanation is also applicable to the second light source 16, which will be not repeated.

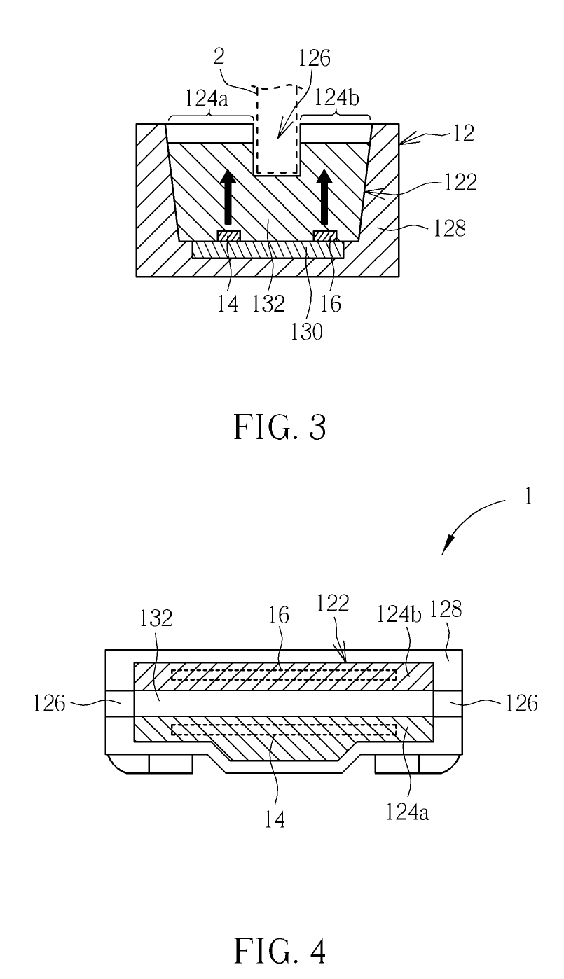

In the embodiment, the insulation carrier 12 includes an insulation cup 128, a lead frame 130 embedded in the insulation cup 128, and a sealing gel 132 accommodated in the package space 122. The positioning groove structure 126 is formed on the cup rim of the insulation cup 128. The first light source 14 and the second light source 16 are disposed on the lead frame 130. The sealing gel 132 covers the first light source 14 and the second light source 16. Therein, the lead frame 130 can include electrode frames and a heat-conduction structure required for the first light source 14 and the second light source 16. In practice, the positioning groove structure 126 is formed for example by cutting, after the first light source 14 and the second light source 16 are packaged by the sealing gel 132, but the invention is not limited thereto. For example, the insulation cup 128 with the positioning groove structure 126 is directly formed by injection. Furthermore, in the embodiment, the positioning groove structure 126 includes two indentations disposed oppositely on the cup rim of the insulation cup 128. The bottom of the indentation is coplanar with the top surface of the sealing gel 132. But the invention is not limited thereto. For example, in a manufacturing design of forming the positioning groove structure 126 by a secondary working, the positioning groove structure 126 can be formed also on the sealing gel 132, as shown by FIG. 3. In this case, the reflection sheet 2 can further extend into the sealing gel 132 for separating the light emitted by the first light source 14 and the second light source 16 more effectively.

Please also refer to FIG. 4. FIG. 4 is a top view of the lighting device 1; therein, the positions of the first light source 14 and the second light source 16 are indicated by dashed lines, and the first light-out area 124a and the second light-out area 124b are still shown by hatched lines. In the embodiment, the lighting device 1 shows a rectangular solid appearance; that is, the insulation cup 128 has a rectangular profile at the light-out side 124. The first light source 14 and the second light source 16 are disposed in a short side direction of the rectangular profile. In practice, each of the first light source 14 and the second light source 16 includes at least one light-emitting diode chip, but the invention is not limited thereto. In a common case, the first light source 14 and the second light source 16 usually use light-emitting diode chips in same size and light-emitting efficiency, so for simple illustration in the description, the ratio of the light-out quantity of the light-emitting diode chips of the first light source 14 to that of the second light source 16 is directly indicated by the ratio of the size of the rectangle by dashed lines for the first light source 14 to that for the second light source 16. In other words, the above ratio also indicates the ratio of the light-emitting power of the first light source 14 to that of the second light source 16, as well as the ratio of the light-out quantity of the first light source 14 to that of the second light source 16. In the embodiment, the first light source 14 is equivalent to the second light source 16.

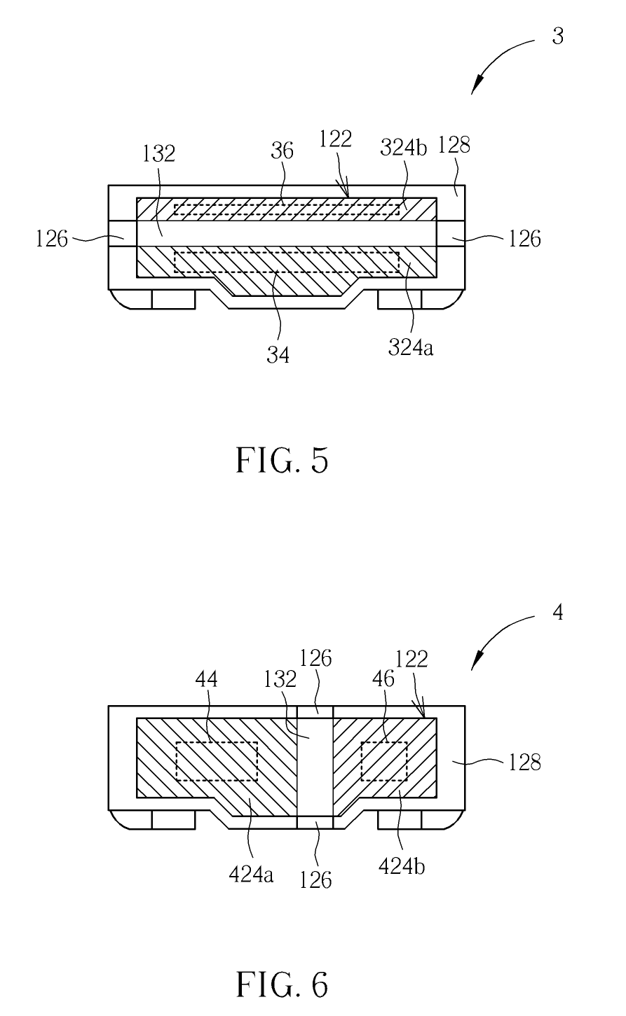

Please refer to FIG. 5, which is a top view of a lighting device according to another embodiment. The lighting device 3 is substantially identical in structure to the lighting device 1. Except for the difference, the lighting device 3 still uses the same denomination as the lighting device 1. The main difference between the lighting device 3 and the lighting device 1 is the disposition of the first light source 34 and the second light source 36 of the lighting device 3. As shown by FIG. 5, the light-emitting power of the first light source 34 is larger than the light-emitting power of the second light source 36, so the light-out quantity from the first light-out area 324a is larger than the light-out quantity from the second light-out area 324b. It is added that if the first light source 34 and the second light source 36 are disposed in the same disposition of light-emitting diode chips (for example, in disposition density), the light-emitting power of the first light source 34 and the second light source 36 can be reflected by the sizes of the areas of the first light-out area 324a and the second light-out area 324b respectively. For example, in the embodiment, the area of the first light-out area 324a corresponding to the first light source is larger than the area of the second light-out area 324b corresponding to the second light source 36. For other description about the lighting device 3, please refer to the relevant description of the lighting device 1. It will not be repeated.

Please refer to FIG. 6, which is a top view of a lighting device according to another embodiment. The lighting device 4 is substantially identical in structure to the lighting device 1. Except for the difference, the lighting device 4 still uses the same denomination as the lighting device 1. The main difference between the lighting device 4 and the lighting device 1 is the disposition of the first light source 44 and the second light source 46 of the lighting device 4. As shown by FIG. 6, the first light source 44 and the second light source 46 are disposed in a long side direction of the rectangular profile. The light-emitting power of the first light source 44 is larger than the light-emitting power of the second light source 46, so the light-out quantity from the first light-out area 424a is larger than the light-out quantity from the second light-out area 424b. For other description about the lighting device 4, please refer to the relevant description of the lighting devices 1 and 3. It will not be repeated.

It is added that, in the above embodiments, the lighting devices 1, 3 and 4 are illustrated to be with a top-view rectangular profile, but the invention is not limited thereto. For example, a top-view square profile, a top-view circular profile, and other top-view profiles are applicable to the invention, which will not be repeated.

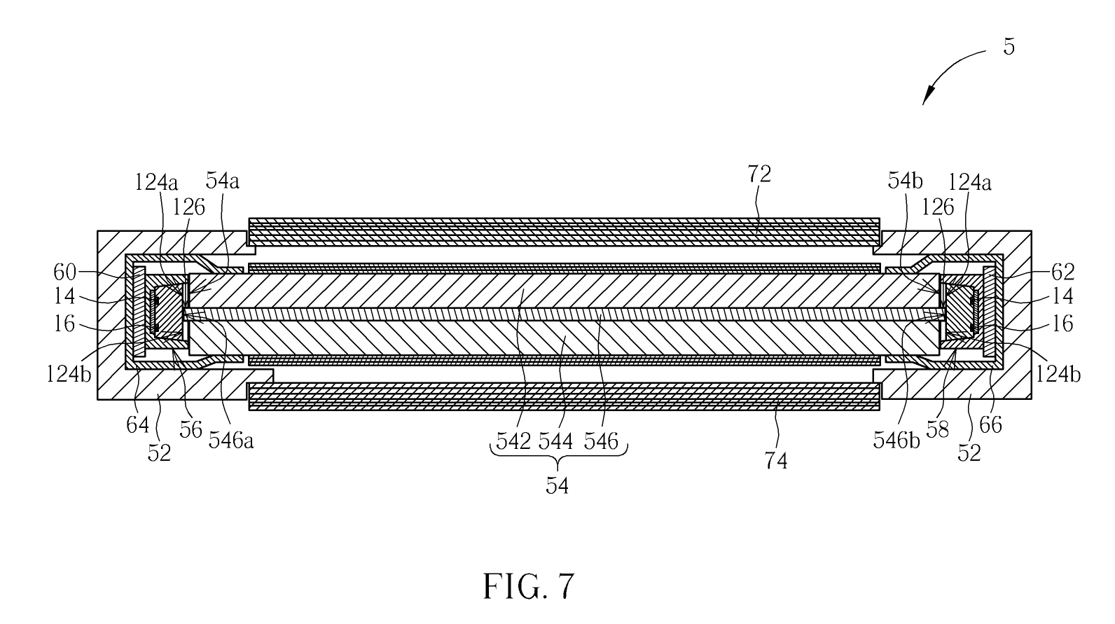

Please refer to FIG. 7, which is a sectional view of a back light module 5, which has a lighting device of the invention, of a preferred embodiment according to the invention. Therein, for simple illustration, the components are shown by magnifying. The back light module 5 includes a frame 52, a light-guiding structure 54, and a first lighting device 56 and a second lighting device 58 disposed at two sides of the light-guiding structure 54. For simple explanation, the embodiment uses the abovementioned lighting device 1 as the first lighting device 56 and the second lighting device 58. Thus, the denomination for the first lighting device 56 and the second lighting device 58 directly follows the denomination of the lighting device 1, and the relevant description of the lighting device 1 is also applicable herein and is not repeated herein. The light-guiding structure 54 includes a first light-guiding part 542, a second light-guiding part 544 disposed opposite to the first light-guiding part 542, and a reflection sheet 546 disposed between the first light-guiding part 542 and the second light-guiding part 544. The light-guiding structure 54 has a first light-in side 54a and a second light-in side 54b opposite to each other. The first lighting device 56 is disposed close to the first light-in side 54a. A first edge 546a of the reflection sheet 546 contacts the positioning groove structure 126 of the first lighting device 56 to divide the light-out side 124 into the first light-out area 124a and the second light-out area 124b of the first lighting device 56, such that the first light-out area 124a and the second light-out area 124b are opposite to the first light-guiding part 542 and the second light-guiding part 544 respectively. Therefore, light emitted by the first light source 14 emitting through the first light-out area 124a out of the first lighting device 56 to enter the first light-guiding part 542 through the first light-in side 54a; light emitted by the second light source 16 emitting through the second light-out area 124b out of the second lighting device 58 to enter the second light-guiding part 544 through the second light-in side 54b. Similarly, the second lighting device 58 is disposed opposite to the first lighting device 56 and close to the second light-in side 54b, such that a second edge 546b of the reflection sheet 546 contacts the positioning groove structure 126 of the second lighting device 58 to divide the light-out side 124 into the first light-out area 124a and the second light-out area 124b of the second lighting device 58. Other detailed disposition of the second lighting device 58 is the same as the first lighting device 56, which will not be repeated.

In the embodiment, the back light module 5 is applied to a bi-directional display apparatus, so in FIG. 7, each of the first light-guiding part 542 and the second light-guiding part 544 thereon disposes a liquid crystal panel 72 and 74. Each of the first light-guiding part 542 and the second light-guiding part 544 is a light-guiding plate for providing required back light to the liquid crystal panels 72 and 74 correspondingly. The first light-guiding part 542, the second light-guiding part 544, and the reflection sheet 546 are stacked in a sandwich structure. It is added that, in practice, the back light module 5 includes a plurality of the lighting devices 56 and 58 at the first light-in side 54a and the second light-in side 54b respectively. Each group of the lighting devices 56 and the lighting devices 58 is arranged and soldered in a row on a circuit board 60 and 62 to form a bar light source module. Furthermore, in the above embodiment, the back light module 5 uses the first lighting device 56 and the second lighting device 58 disposed opposite to each other; that is, the first light-in side 54a is opposite to the second light-in side 54b. The light-out uniformity of the first light-guiding part 542 and the second light-guiding part 544 is therefore improved. However, the invention is not limited thereto. For example, if the intensity of the back light provided by the first lighting devices 56 is sufficient, the second lighting devices 58 can be omitted; in practice, the first light-in side 54a and the second light-in side 54b can be disposed to be adjacent; even lighting devices can be disposed at several sides of the light-guiding structure 54. In addition, in the embodiment, the back light module 5 includes reflection plates 64 and 66 at the lighting devices 56 and 58 respectively, which provides effect of fixing the lighting devices 56 and 58 and the light-guiding structure 54 and preventing light leakage thereby. The frame 52 can directly support the liquid crystal panels 72 and 74; the reflection plates 64 and 66 support the light-guiding structure 54 and the lighting devices 56 and 58.

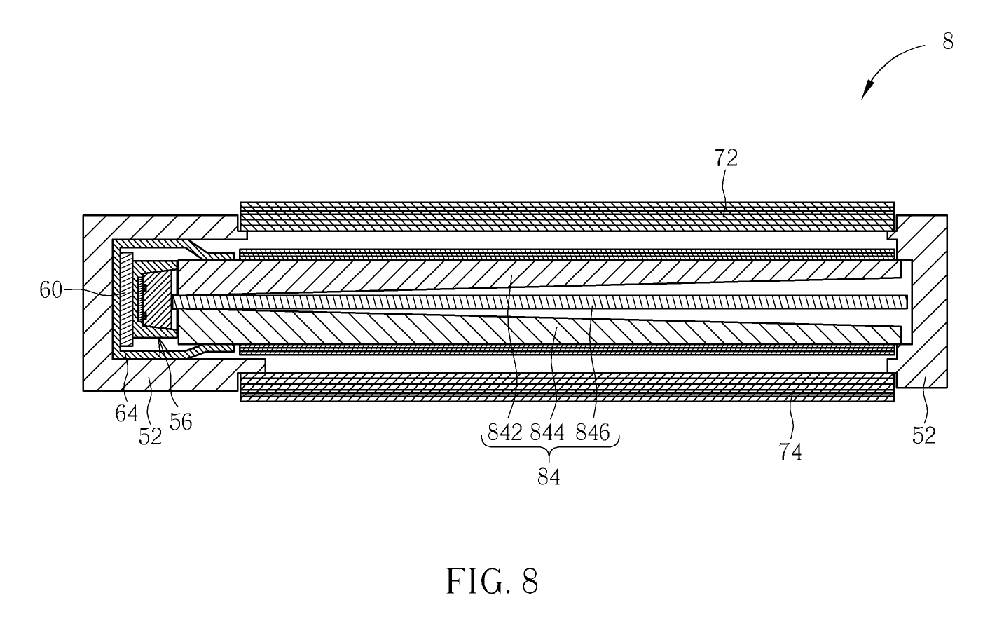

In the above embodiments, each of the first light-guiding part 542 and the second light-guiding part 544 is a flat plate, but the invention is not limited thereto. Please refer to FIG. 8, which is a sectional view of a back light module 8 according to another embodiment. The back light module 8 is substantially identical in structure to the back light module 5. Except for the difference, the back light module 8 still uses the same denomination as the back light module 5. The main difference between the back light module 8 and the back light module 5 is that each of the first light-guiding part 842 and the second light-guiding part 844 of the first light-guiding part 842 of the light-guiding structure 84 of the back light module 8 is a wedge light-guiding plate, which is conducive to the light-out uniformity of the first light-guiding part 842 and the second light-guiding part 844, so the back light module 8 is provided with the lighting device 56 only at one side of the light-guiding structure 84.

In addition, it is added that the lighting device of the invention can provide different light-out quantities; that is, the back light module provides different the light-out quantities by different light-guiding parts, so the back light intensity provided by the first light-guiding part and the second light-guiding part can be controlled by way of designing the light-out quantities provided by the lighting device through the first light-out area and the second light-out area respectively, so as to be adapted to different requirements of different products. For an example of a foldable mobile phone with dual screens, the outside screen thereof is usually small and used for indication display, so the back light intensity therefor is usually not high and the back light-out quantity is less. For this case, the lighting device 3 in FIG. 5 is applicable.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device, comprising:
an insulation carrier having a package space and a light-out side, the light-out side thereon defining a first light-out area and a second light-out area, the insulation carrier comprising a positioning groove structure for positioning a reflection sheet such that the reflection sheet divides the light-out side into the first light-out area and the second light-out area;
a first light source disposed in the package space corresponding to the first light-out area, light emitted from the first light source emitting through the first light-out area out of the lighting device; and
a second light source disposed in the package space corresponding to the second light-out area, light emitted from the second light source emitting through the second light-out area out of the lighting device.

2. The lighting device of claim 1, wherein the insulation carrier comprises an insulation cup, and the positioning groove structure is formed at a cup rim of the insulation cup.

3. The lighting device of claim 2, wherein the insulation carrier comprises a sealing gel accommodated in the package space for covering the first light source and the second light source, and the positioning groove structure is also formed on the sealing gel.

4. The lighting device of claim 2, wherein the insulation cup has a rectangular profile at the light-out side, and the first light source and the second light source are disposed in a long side direction of the rectangular profile.

5. The lighting device of claim 2, wherein the insulation cup has a rectangular profile at the light-out side, and the first light source and the second light source are disposed in a short side direction of the rectangular profile.

6. The lighting device of claim 1, wherein the first light source comprises at least one light-emitting diode chip.

7. The lighting device of claim 1, wherein a light-emitting power of the first light source is larger than a light-emitting power of the second light source.

8. The lighting device of claim 1, wherein the first light-out area is larger than the second light-out area.

9. A back light module, comprising:
a light-guiding structure having a first light-in side, the light-guiding structure comprising:
a first light-guiding part;
a second light-guiding part disposed opposite to the first light-guiding part; and
a reflection sheet disposed between the first light-guiding part and the second light-guiding part; and
a first lighting device disposed close to the first light-in side and contacting a first edge of the reflection sheet, the first lighting device comprising:
an insulation carrier having a package space and a light-out side opposite to the first light-in side, the light-out side thereon defining a first light-out area and a second light-out area, the insulation carrier comprising a positioning groove structure, the first edge of the reflection sheet being disposed in the positioning groove structure to divide the light-out side into the first light-out area and the second light-out area, such that the first light-out area and the second light-out area are opposite to the first light-guiding part and the second light-guiding part respectively;
a first light source disposed in the package space corresponding to the first light-out area, light emitted from the first light source emitting through the first light-out area out of the first lighting device to enter the first light-guiding part through the first light-in side; and
a second light source disposed in the package space corresponding to the second light-out area, light emitted from the second light source emitting through the second light-out area out of the first lighting device to enter the second light-guiding part through the first light-in side.

10. The back light module of claim 9, wherein the insulation carrier comprises an insulation cup, and the positioning groove structure is formed at a cup rim of the insulation cup.

11. The backlight module of claim 10, wherein the insulation carrier comprises a sealing gel accommodated in the package space for covering the first light source and the second light source, and the positioning groove structure is also formed on the sealing gel.

12. The backlight module of claim 10, wherein the insulation cup has a rectangular profile at the light-out side, and the first light source and the second light source are disposed in a long side direction of the rectangular profile.

13. The backlight module of claim 10, wherein the insulation cup has a rectangular profile at the light-out side, and the first light source and the second light source are disposed in a short side direction of the rectangular profile.

14. The back light module of claim 9, wherein the first light source comprises at least one light-emitting diode chip.

15. The back light module of claim 9, wherein a light-emitting power of the first light source is larger than a light-emitting power of the second light source.

16. The back light module of claim 9, wherein the first light-out area is larger than the second light-out area.

17. The back light module of claim 9, wherein each of the first light-guiding part and the second light-guiding part is a light-guiding plate.

18. The back light module of claim 17, wherein the light-guiding plate is a wedge light-guiding plate.

19. The back light module of claim 9, further comprising a second lighting device, wherein the light-guiding structure has a second light-in side, the second lighting device is disposed close to the second light-in side and contacts a second edge of the reflection sheet, and the second lighting device is identical in structure to the first lighting device.

20. The back light module of claim 19, wherein the second light-in side is opposite to the first light-in side.
